(19) United States
(12) Patent Application Publication
(10) Pub. No.: US 2006/0087928 A1
(43) Pub. Date: Apr. 27, 2006

(54) Mirror element and mirror array

(75) Inventor: Yota Hashimoto, Kasuga-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/258,378

(22) Filed: Oct. 26, 2005

(30) Foreign Application Priority Data
Oct. 27, 2004 (JP) P2004-311781
Oct. 11, 2005 (JP) P2005-296319

(51) Int. Cl. G11B 7/00

(52) U.S. Cl. 369/44.11

(57) ABSTRACT

Providing a mirror element and a mirror array used for an optical pickup of optical apparatus or optical disc apparatus that obtain a large displacement amount with a low voltage The mirror element includes a board; a film including a first piezoelectric body, and a first electrode and a second electrode arranged to sandwich the first piezoelectric body, the film supported by the board; a support provided in the film; and a mirror supported by the film via the support.

### BACKGROUND

1. Field of the Invention

The present invention relates to a mirror element and a mirror array used for an optical pickup of optical apparatus or optical disc apparatus.

2. Description of the Related Art

In the related art, there have been devised a variety of variable-shape mirrors as variable focus and aberration correcting means in optical apparatus such as a microscope and a camera. The demand for such variable-shape mirrors is becoming higher with the expansion of optical disc technologies.

Compact discs (CDs) and digital versatile discs (DVDs) are available as information recording media using optical discs. In recent years, same optical disc apparatus is generally used to read/write data to/from multiple types of recording media. There is a need for more compact optical disc apparatus than related art apparatus. In particular, more compact and lower-profile optical disc apparatus for a laptop PC is in increasing demand. With the development of multimedia technologies, there has been a request for a larger storage or recording capacity of an optical disc. Efforts to increase the recording density include means such as use of a blue laser with a short wavelength and a larger numerical aperture (NA) of an objective lens. Introduction of multiple recording layers in a medium is another effort to expand the recording area thus attaining a large capacity.

Optical disc apparatus comprises a laser light source, an optical pickup and a photoreceptor element. Laser beams emitted from a laser light source are condensed on the data face of an optical disc through an optical pickup and detected by a photoreceptor element after being reflected. Information recorded on the optical disc is thus read or information is written onto the optical disc. In this process, the wavefront of a beam undergoes aberrations caused by various optical components and optical discs. Correction of aberration is essential to proper reading/writing of information. In particular, fixed correction means that uses a lens or a diffraction optical element of an optical pickup is inappropriate for dynamic aberrations that take place while an optical disc is rotating or that accompany readout of data on different layers. Dynamic correction using an actuator is essential in such a case.

The above methods for correcting aberrations have been devised. For example, according to the method described in JP-A-10-241201, a correction lens is moved by an actuator to correct spherical aberration. This method requires a large actuator part and an extra lens so that it is not suited for an optical pickup that must be more compact than ever, especially in use for a PC.

Aberration correcting means using a mirror array serves as a small-sized actuator. Although a method for driving a mirror by way of an electrostatic drive mechanism has been proposed so far, this approach is less practicable because of its high drive voltage. The method described in JP-A-2001-350107 uses a thin-film mirror element that employs a piezoelectric thin film. This method requires a structure where a mirror is supported by a piezoelectric thin film part in the shape of a cantilever beam. This requires a high rigidity of the piezoelectric thin film part and a large drive voltage is required to obtain a large displacement amount. The drive direction is limited to a single axis direction. Thus the freedom is low in terms of the drive direction of the mirror as well as a mirror array including an array of mirror elements. As a result, this approach is only effective in limited types of aberration corrections.

### SUMMARY

An object of the invention is to provide a mirror element and a mirror array that obtain a large displacement amount with a low voltage.

The invention provides a mirror element comprising: a board; a film including a first piezoelectric body, and a first electrode and a second electrode arranged to sandwich the first piezoelectric body, the film supported by the board; a support provided with the film; and a mirror supported by the film via the support.

According to the invention, it is possible to obtain a large displacement amount with a low voltage because a mirror is supported by a film via a support.

### BRIEF DESCRIPTION OF THE DRAWINGS

FIG. 1 A and B show a mirror element according to an embodiment of the invention;

FIG. 2 A, B and C are plan views of a mirror element according to the embodiment of the invention;

FIG. 3 A, B and C show a mirror element according to the embodiment of the invention;

FIG. 4 A, B, C and D are plan views of a mirror array according to the embodiment of the invention;

FIG. 5 A, B, C, D and E are plan views showing the manufacturing process of the mirror element according to the embodiment of the invention;

FIG. 6 shows an optical path of an optical pickup according to the embodiment of the invention; and

FIG. 7 shows an optical path of an optical pickup according to the embodiment of the invention.

### DETAILED DESCRIPTION

An embodiment of the invention will be described in detail referring to drawings. The dimension of the film thickness, thickness of the board, or displacement amount in the drawings is different from the actual dimension for easy understanding.

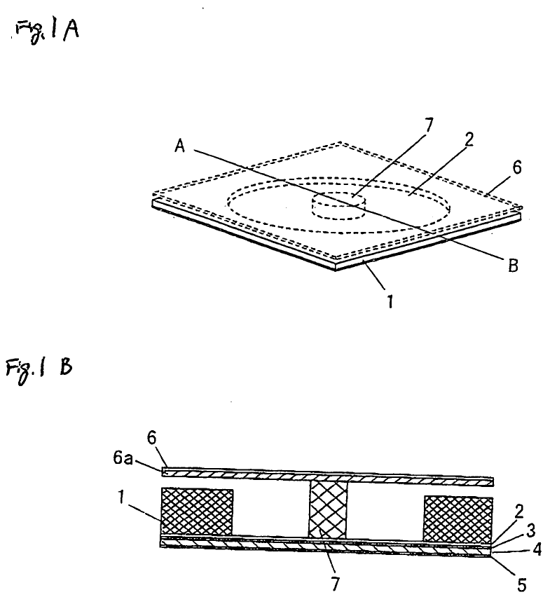

FIG. 1A is a perspective view of a mirror element according to an embodiment of the invention where a mirror 6 is shown transparent for explanation. FIG. 1B is a cross sectional view taken along the line A-B in FIG. 1A. As shown in FIG. 1B, the mirror element according to this embodiment comprises: a drive part including a diaphragm as a laminated thin film including a first piezoelectric body 4, a first electrode 3 and a second electrode 5 arranged to sandwich the first piezoelectric body 4 and an elastic film 2 and a board 1 for supporting the diaphragm. Part of the diaphragm and the mirror 6 are coupled together by a mirror support 7. The mirror 6 that reflects light is provided on the rear surface of a portion supported by the mirror support 7.

In this way, the mirror element according to this embodiment includes a mirror support 7 provided in the elastic film 2 of the laminated thin film and the mirror 6 supported by the laminated thin film via the mirror support 7 and the board 6a, so that it is capable of substantially displacing the mirror 6.

The structure shown in FIG. 1 is only exemplary. The film thickness of each film, presence/absence of an elastic film, or shape of a diaphragm or the mirror 6 is not particularly limited to that shown in FIG. 1.

Next, the drive principle of the mirror element will be described. Applying a voltage to the first electrode 3 and the second electrode 5 deforms the diaphragm. The mirror support 7 provided in the diaphragm and the mirror 6 are driven with the deformation of the diaphragm. In case the joint part of the mirror support 7 is in the center of the diaphragm, the mirror 6 is driven only in vertical direction (laminating direction of the diaphragm) unless an electrode is divided. The mirror 6 may be tilted in an arbitrary direction by dividing an electrode into at least three pieces.

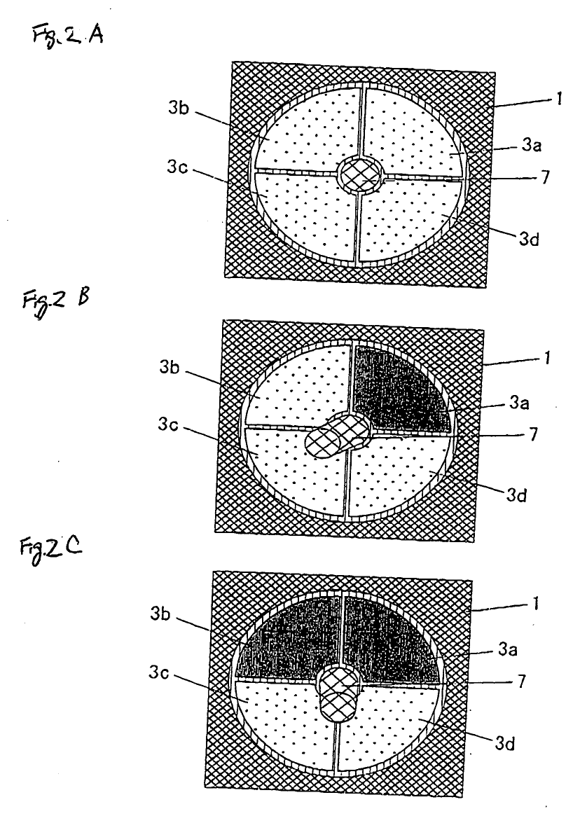

Operation of a case where four electrodes are provided will be described referring to FIG. 2. FIG. 2 is a plan view of the drive part and mirror support 7 according to this embodiment. FIG. 2 does not show the mirror 6 and the board 6a from the mirror element according to this embodiment shown in FIG. 1. The mirror support 7 in the shape of a cylinder is positioned in the center of the diaphragm. A first electrode is divided radially about the mirror support 7. In other words, boundaries between the first divided electrodes 3a, 3b, 3c, 3d are arranged radially about the mirror support 7. The first electrodes 3a, 3b, 3c, 3d each has a shape of an approximate sector having a central angle of 90 degrees. Its shape and area are the same or symmetrical. The potential of the second electrode is fixed to 0 volts. In case no voltage or same voltage is applied to the first electrodes 3a, 3b, 3c, 3d, the mirror support 7 is not tilted as shown in FIG. 2A.

In case a voltage is applied to the first electrode 3a alone or in case a voltage is applied to the electrode 3a that is different from that applied to the first electrodes 3b, 3c, 3d, the mirror support 7 is tilted in lower left direction as shown in FIG. 2B. In case the same voltage is applied to the first electrodes 3a, 3b, the mirror support 7 is tilted downward as shown in FIG. 2C. In this case, by changing stepwise the magnitude of the voltage applied to the first electrode 3a or the first electrode 3b, it is possible to control stepwise the mirror support 7 from the position shown in FIG. 2B to the position shown in FIG. 2C thereby controlling the magnitude of tilting of the mirror support by changing the magnitude of voltage applied to each electrode. As a result of simulation using ANSYS™ from ANSYS, Inc., it is known that the mirror support 7 is tilted downward by 0.3 degrees when a voltage of 0.5 volts is applied to each of the first electrode 3a and the first electrode 3b under the conditions of a diaphragm of 100 μm in diameter, an elastic film of 1 μm in thickness, a first electrode of 0.1 μm in thickness, a piezoelectric body of 1 μm in thickness, and a second electrode of 0.2 μm in thickness. This result shows a drive amount sufficient as an actuator for correction of aberration.

In this example, the mirror element comprises: a drive part having a diaphragm structure that includes a laminated thin film including a first piezoelectric body 4, a first electrode 3 and a second electrode 5 arranged to sandwich the piezoelectric body 4 and a board 1 for supporting the laminated thin film; and a mirror 6 at least part of which reflects light. Part of a base material for supporting the mirror 6 is integrated with the diaphragm. Thus, the drive part has a diaphragm structure including a laminated thin film and the board 1. This obtains a large displacement amount with a low voltage.

Either of both of the first electrode 3 and the second electrode 5 are divided into at least two pieces.

While the mirror 6 may be driven in vertical direction only in case each electrode is not divided, the angle of tilting of the mirror 6 may be adjusted by dividing each electrode into electrode pieces. In case an electrode is divided into two, the direction of tilting is twofold. In case an electrode is divided into three pieces, it is possible to tilt the mirror support in an arbitrary direction by way of voltage control. It is this more favorable to divide an electrode into three pieces or more.

By providing the mirror support 7 in the approximate center of a portion supported by the board 1 in the laminated thin film, the distances from the fixed end of the laminated thin film supported by the board 1 to the mirror support 7 are made equal. It is thus possible to accurately tilt the mirror 6 in a desired direction via the mirror support 7.

The electrode is divided into four pieces almost radially about the mirror support 7 in this example. In case the electrode is divided into two pieces, each electrode has a shape of an approximate sector having a central angle of 180 degrees about the mirror support 7. In case the electrode is divided into three pieces, each electrode has a shape of an approximate sector having a central angle of 120 degrees about the mirror support 7. That is, in case an electrode is divided into n pieces (N≧2), arranging electrodes that have a shape of an approximate sector having a central angle of 360/n degrees about the mirror support 7 facilitates control of the direction into which the mirror 6 is tilted.

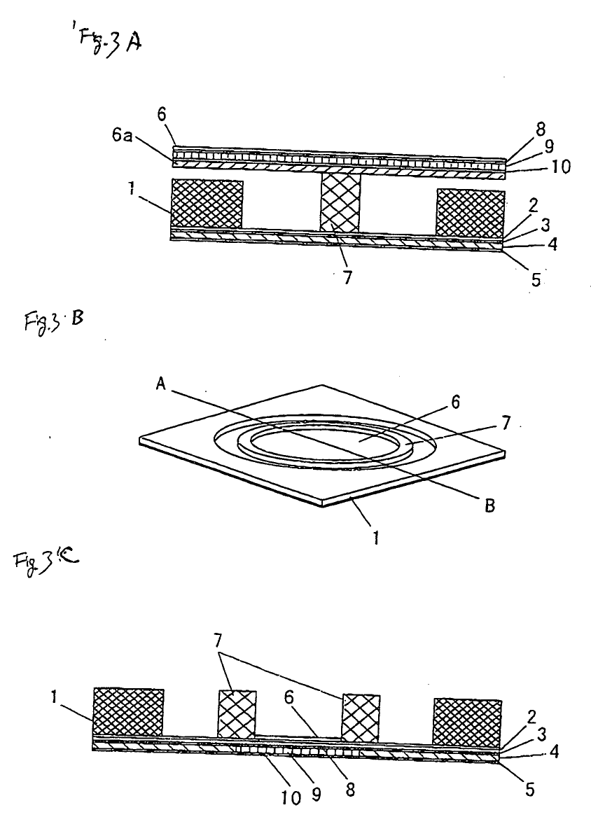

FIG. 3 shows an exemplary mirror structure assumed in case the mirror is driven. The mirror element shown in FIG. 3A comprises, in the mirror 6, a second piezoelectric body 9 and a third electrode 8 and a fourth electrode 10 arranged to sandwich the second piezoelectric body 9. This makes variable the shape of the mirror 6 including a minute change to the shape of the mirror, thus allowing accurate aberration correction.

FIG. 3B is a schematic diagram of a diaphragm structure comprising, in the mirror 6 provided in a ring-shaped mirror support 7, a second piezoelectric body 9 and a third electrode 8 and a fourth electrode 10 arranged to sandwich the second piezoelectric body 9. FIG. 3C is a cross sectional view taken along the line A-B in FIG. 3B. This structure allows substantial change to the shape of the mirror 6 and allows a mirror element as a standalone component to be used as an aberration correction element equipped with a tilt function.

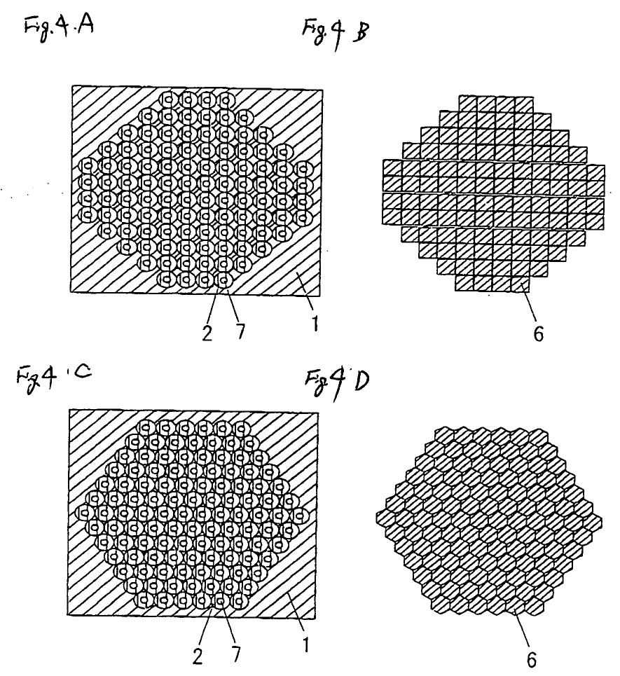

FIGS. 4A and 4C show examples of arrangement of the drive part of the mirror element. FIGS. 4B and 4D show examples of arrangement of the mirror 6 corresponding to the above examples. Between the arranged mirrors 6 is provided a spacing that avoids collision of the mirrors 6 even when individual mirror elements are driven independently. By arranging the mirror elements according to this embodiment to form a mirror array, it is possible to arbitrarily change the entire surface shape thus correcting any type of aberration. The mirror array may be used as a DMD (Digital Micromirror Device) used for a projector of the DLP™ (Digital Light Processing) system.

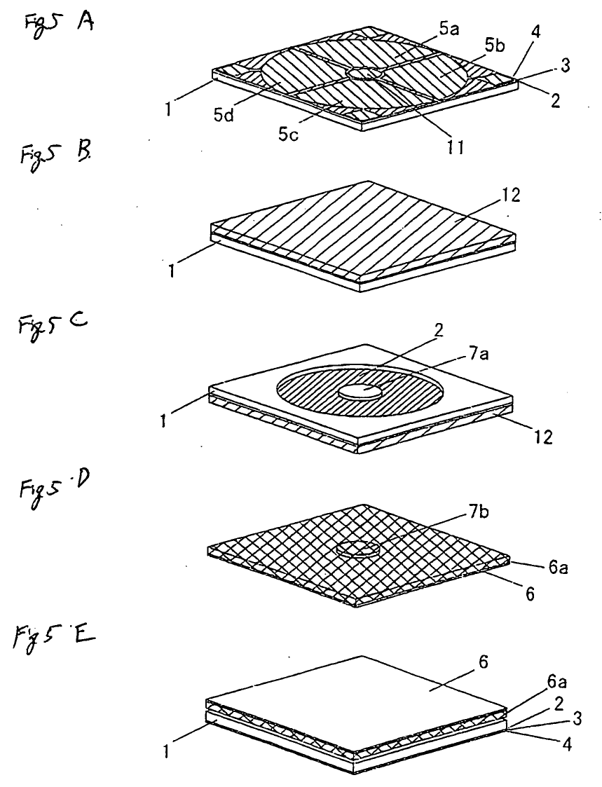

FIGS. 5A through 5E are schematic diagrams of a mirror element in each manufacturing process of the mirror element. A method for manufacturing a mirror element according to this embodiment will be described referring to FIG. 5.

First, a method for manufacturing components of a drive part will be described. The board 1 of the drive part is an Si board having a thermal oxide film. The thermal oxide film serves as an elastic film 2. In case the elastic film 2 is not used or in case another material is used for the elastic film 2, the thermal oxide film is not required. As a material of the board, a metal, a metal oxide or a resin may be used as well as Si.

Films of the first electrode 3 and the first piezoelectric body 4 are grown on the board 1. Patterning is made on the first piezoelectric body 4 to provide conduction of the first electrode 3. A film of the first electrode 3 is grown via sputtering, evaporation, CVD, electrodeposition, or electroless deposition. As a method for etching the first piezoelectric body 4, a general semiconductor process is used in which a photoresist is applied and patterned and the resulting photoresist is used as a mask to perform wet etching or dry etching on the piezoelectric body. The result of the additional growing of a film of the second electrode 5 and patterning on the same is shown in FIG. 5A. The second electrode 5 is divided into five pieces in this example. Of these electrodes, four electrodes are used as second electrodes 5a, 5b, 5c, 5d and one electrode is used as an electrode pad 11 for the first electrode 3.

Then a photoresist and a resin are applied in this order. The resin is caked to form a diaphragm fixing body 12. In this stage, the mirror element in the manufacturing process has layers laminated including: the board 1, the elastic film 2, the third electrode 3, the first piezoelectric body 4, the second electrode 5, the photoresist of the diaphragm fixing body 12, and the resin of the diaphragm fixing body 12 in this order. Formation of the diaphragm fixing body 12 is intended to facilitate the subsequent tasks by fixing the diaphragm. Note that the diaphragm fixing body 12 is not a member of a final mirror element. Application of a photoresist is intended to facilitate peeling-off of the resin.

The element shown in FIG. 5B is turned over and Si etching is made to form the board 1. The etching complete state is shown in FIG. 5C. The etching method is the same as that for the first piezoelectric body 4 described above and includes patterning by way of a photoresist followed by wet etching or dry etching. While the shape of the diaphragm, that is, the shape of the inner edge of the board 1 is a circle in FIG. 5C, a variety of shapes may be taken including an oval, a rectangle, a polygon, and a star. In the etching process, part of the board 1 is left in the center of the diaphragm to form a base material 7a of the mirror support 7.

Next, a method for manufacturing the components of the mirror 6 will be described. A film of mirror is grown on the Si board as the board 6a of the mirror 6. As a material of the board 6a, a metal, a metal oxide or a resin may be used as well as Si. A material of the mirror 6 is not particularly limited although a metallic film or a laminated film of a metal oxide is preferably used for improved reflectivity. Same as the formation of the base material 7a, it is possible to form the base material 7b as a part of the mirror support 7 by etching on the board 6a at the rear surface of the mirror 6, as shown in FIG. 5B. The etching method is described earlier.

Finally, a component serving as a drive part and a component serving as the mirror 6 that have been manufactured are bonded together. The photoresist and the resin forming the diaphragm fixing body 12 used to fix the diaphragm are peeled off. A method for bonding the drive part and the mirror 6 (to be more precise, the base materials 7a and 7b) together may be bonding by using an adhesive or melt adhesion. The diaphragm has been fixed with a resin because the diaphragm needs to be held down in adhesion. In a coupling method that does not require the diaphragm to be held down, the diaphragm fixing body to fix the diaphragm may be done without. While the base materials 7a and 7b are bonded together to form the mirror support 7 in this example, a member other than the board 1 or board 6a may be used to form the mirror support 7 and couple the mirror support 7 to the elastic film 2 and the board 6a.

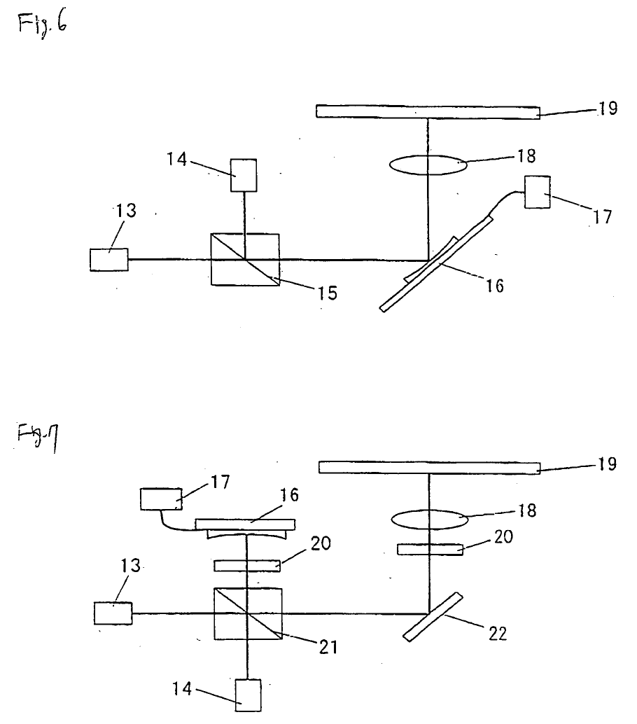

FIG. 6 shows a basic configuration example of an optical pickup using a mirror array including mirror elements according to this embodiment. Luminous flux emitted from a laser light source 13 passes through a beam splitter 15, is reflected by a mirror array also serving as a starting mirror, passes through an objective lens 18 and forms an image on an optical disc 19. The light reflected on the optical disc 19 is reflected by the mirror array 16 and is reflected by the beam splitter 15 and converted to an electric signal by a photoreceptor element 14.

In this configuration, the luminous flux is incident on the mirror array 16 at an angle of 45 degrees. A control voltage is fed from a driver 17 to the mirror array 16 including variable-shape mirror elements. The driver 17 determines the value of the control voltage based on at least one signal in the photoreceptor part of a monitoring photoreceptor element (not shown) for detecting the aberration amount or the photoreceptor element 14, and changes the surface shape of the mirror array 16. In case the outgoing light from the laser light source 13 is short-wavelength light from blue to bluish purple, the above configuration is particularly useful.

A configuration shown in FIG. 7 may be also implemented as an optical pickup using a mirror array including mirror elements according to this embodiment. The luminous flux emitted from the laser light source 13 passes through a polarization beam splitter 21, is reflected on a starting mirror 22, passes through a quarter-wave plate 20 and an objective lens 18, and is condensed on an optical disc 19. The light reflected on the optical disc 19 changes the polarization state by 90 degrees, passes through the starting mirror 22, is reflected on the polarization beam splitter 21, passes through another quarter-wave plate 20 and is reflected on the mirror array 16, passes through the quarter-wave plate 20 again to change the polarization state by 90 degrees, and passes through the polarization beam splitter 21, and is converted to an electric signal by the photoreceptor element 14.

A control voltage is fed from the driver 17 to the mirror array. The driver 17 determines the value of the control voltage based on at least one signal in the photoreceptor part of a monitoring photoreceptor element (not shown) for detecting the aberration amount or the photoreceptor element 14, and changes the surface shape of the mirror array 16. In case the outgoing light from the laser light source 13 is short-wavelength light from blue to bluish purple, the above configuration is particularly useful.

The embodiment of the invention has been accomplished in order to solve the aforementioned problems. An object of the invention is to provide a mirror element that obtains a large displacement amount with a low voltage and that has a freedom in the drive direction as well as a mirror array that has a freedom of shape and corrects various types of aberration.

The invention is applicable to an optical pickup used for a focus of optical apparatus such as a microscope and a camera as well as a CD/DVD drive recorder, a decoder, and a CD/DVD drive, and in particular to an optical pick using a blue laser and optical apparatus that requires correction of aberration.

The inventive mirror element allows tilt adjustment, which makes it available as an optical attenuator or as a DMD (Digital Micromirror Device) used for a projector of the DLP™ (Digital Light Processing) system.

This application is based upon and claims the benefit of priority of Japanese Patent Application No 2004-311781 filed on 2004 Oct. 27, Japanese Patent Application No 2005-296319 filed on 2005 Oct. 11; the contents of which are incorporated herein by reference in its entirety.

What is claimed is:

1. A mirror element, comprising:
a board;
a film, including a first piezoelectric body, and a first electrode and a second electrode arranged to sandwich the first piezoelectric body, the film supported by the board;
a support, provided in the film; and
a mirror supported by the film via the support.

2. The mirror element according to claim 1, wherein at least one of the first electrode and the second electrode is divided into at least two pieces.

3. The mirror element according to claim 1, wherein the support is provided in the approximate center of a portion supported by the board in the films.

4. The mirror element according to claim 3, wherein at least one of the first electrode and the second electrode is divided almost radially about the support.

5. The mirror element according to claim 3, wherein at least one of the first electrode and the second electrode is divided almost radially at a constant angle about the support.

6. The mirror element according to claim 1, wherein the mirror has a portion that reflects light at the rear surface of the portion supported by the support.

7. The mirror element according to claim 1, wherein the mirror includes a second piezoelectric body and a third electrode and a fourth electrode arranged to sandwich the second piezoelectric body.

8. The mirror element according to claim 7, wherein the mirror has a diaphragm structure.

9. A mirror element, comprising:
a mirror, at least part of which reflects light;
a support for supporting the mirror;
a film, with which the support is provided; and
a board for supporting the film;
wherein the film includes a first piezoelectric body and a first electrode and a second electrode arranged to sandwich the first piezoelectric body and that the circumference of a portion where the support is provided is supported by a board.

10. A mirror array characterized by arranging the mirror element according to claim 1.

11. A mirror array characterized by arranging the mirror element according to claim 2.

12. A mirror array characterized by arranging the mirror element according to claim 3.

13. A mirror array characterized by arranging the mirror element according to claim 4.

14. A mirror array characterized by arranging the mirror element according to claim 5.

15. A mirror array characterized by arranging the mirror element according to claim 6.

16. A mirror array characterized by arranging the mirror element according to claim 7.

17. A mirror array characterized by arranging the mirror element according to claim 8.

18. A mirror array characterized by arranging the mirror element according to claim 9.
